(19) United States
(12) Patent Application Publication
(10) Pub. No.: US 2019/0016334 A1
(43) Pub. Date: Jan. 17, 2019

(54) METHOD AND SYSTEM FOR ASSISTING THE DRIVING OF AN AUTONOMOUS VEHICLE ON A ROAD HAVING REQUIRED PASSING ZONES

(71) Applicant: PSA Automobiles SA, Poissy (FR)

(72) Inventors: STEFANO MAFRICA, PARIS (FR); RACHID ATTIA, VERSAILLES (FR); AUDREY MANDARD, PARIS (FR); AUDREY RIZZO, SURESNES (FR)

(21) Appl. No.: 16/031,422

(22) Filed: Jul. 10, 2018

(30) Foreign Application Priority Data
Jul. 12, 2017 (FR) 1756609

(51) Int. Cl. B60W 30/10; G05D 1/00; G01C 21/30; G06F 17/30; G08G 1/0968

(52) U.S. Cl. CPC B60W 30/10; G05D 1/0088; G01C 21/30; B60W 2550/402; G08G 1/096822; G05D 2201/0213; G06F 17/30241

(57) ABSTRACT

A method for assisting the driving of a vehicle (V) on a road (R) having a portion (PV) with mandatory passing zones (ZP11-ZP22), wherein the vehicle (V) is capable to communicate by over-the-air waves and to be driven autonomously. The method comprises a step where, when the vehicle (V) reaches the vicinity of the portion of the road, the vehicle's relative position with respect to a predefined location of at least one mandatory passing zone (ZP21) is determined, then a path to follow passing through a mandatory passing zone (ZP21) is determined as a function of mapping information defining the mandatory passing zones, traffic information in the mandatory passing zones and the determined relative position of the vehicle, and then the driving of the vehicle (V) is controlled so that it takes this path to follow.

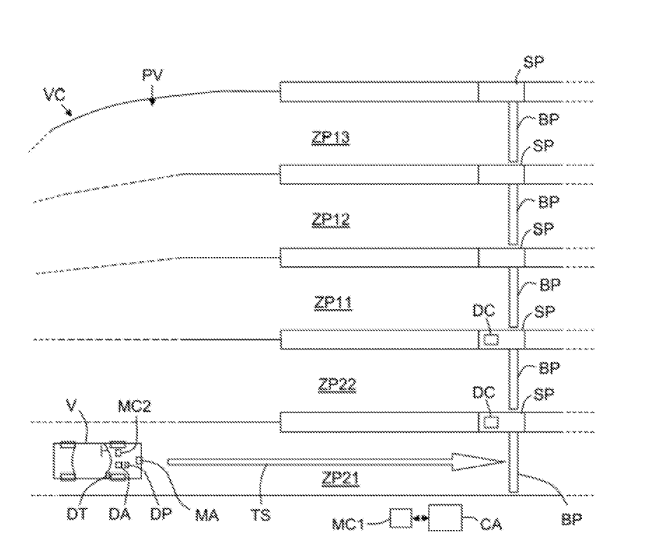

### CROSS-REFERENCE TO RELATED APPLICATIONS

The present application claims priority to French App. No. 1756609 filed Jul. 12, 2017 which is incorporated herein by reference

### BACKGROUND OF THE INVENTION

The invention relates to autonomously driven vehicles, possibly of the automotive type, and more specifically assistance in driving such vehicles.

Certain vehicles, generally of automotive type, comprise a driver assistance device (for example of the Advanced Driver Assistance System (ADAS) type) which is responsible for controlling their positioning with respect to the transverse and longitudinal directions (and therefore according to the traffic lane used) to allow their driving at least partially autonomously, that is to say without their drivers using their steering wheels or pedals. Such assistance devices are therefore able to, at least partially, control the dynamics (direction, speed and acceleration) of their vehicle based on information representative of the environment of the vehicle and its current position.

Currently, this type of assistance device does not allow control of the autonomous driving in certain driving situations, and especially when the vehicle is going through a mandatory passing zone on a road, such as, for example, a toll road or tunnel or bridge or parking. Thus, when the vehicle reaches the mandatory passing zone, its driver must regain full control for security reasons, because its assistance device is not designed to control driving in this zone, including when it is a mandatory passing zone known as automated because it allows controlled automatic passing of vehicles that are authorized to pass in a controlled manner.

This is mainly because driver assistance is currently based on an analysis of the vehicle environment by on-board means based on the presence of markings on the ground and/or mapping defining the different mandatory passing zones of a portion of roadway (as described in French Pat No. FR3007724). However, such driving assistance is currently very difficult, if not impossible, because most of the mandatory passing zones do not have ground markings and there is no precise mapping defining them. In addition, it is very common for restricted areas to be closed temporarily, which may lead to the selection of a closed passing zone.

In addition, the satellite guidance function (for example of the GPS type) which makes it possible to provide the current position of the vehicle to its assistance device, does not function, or, at best, works in an imprecise manner which is unsuitable for guidance with an accuracy of a few centimeters, when the vehicle is in a covered area (for example in a building car park or a tunnel or a toll station with a roof or awning.

Furthermore, the on-board sensors that provide data to the vehicle analysis means are not currently capable of correctly detecting a barrier and a traffic light in the lane of a mandatory passing zone, and therefore this analysis means has real difficulties in determining when passing is allowed.

As a result, the current operation of assistance devices does not correspond to what users expect from autonomous vehicles.

### SUMMARY

The invention therefore aims particularly to improve this situation.

For this purpose, a method is disclosed for assisting the driving of a vehicle on a road comprising a portion provided with at least two mandatory passing zones, the vehicle communicating by over-the-air waves and being autonomously driven according to its position.

This assistance method is characterized in that it comprises a step which, when the vehicle reaches the vicinity of the road portion, consists of:
determining a relative position of this vehicle with respect to a predefined location of at least one mandatory passing zone, then
determining for this vehicle a path to follow which passes through a mandatory passing zone according to mapping information defining at least some of the mandatory passing zones, to traffic information defining traffic in at least some of the mandatory passing zones and to this/each relative position determined, then
controlling the driving of this vehicle using this path to follow.

Thus, when the vehicle arrives in a portion of road having mandatory passing zones, its driving assistance device is able to properly and accurately manage its dynamics throughout the traverse of a mandatory passing zone, without its driver having to intervene (at least in driving).

The assistance method according may comprise other features that can be applied separately or in combination, and in particular:
in a first embodiment, in its step, it is possible to determine each relative position of the vehicle and the path to follow in a computer associated with the road portion, and then a definition of this path can be transmitted from the computer to the vehicle;
in a second embodiment, in its step, it is possible to determine each relative position of the vehicle and trajectories passing respectively through at least some of the mandatory passing zones in a computer associated with the road portion, and then it is possible to transmit from this computer to the vehicle definitions of these determined trajectories, the mapping information defining at least some of the mandatory passing zones, the traffic information defining the traffic in at least some of the mandatory passing zones, and the position information defining each determined relative position, then it is possible to select in the vehicle the path to follow among the determined trajectories according to this mapping information, traffic information and position information;
in a third embodiment, in its step, it is possible to determine each relative position of the vehicle in a computer associated with the road portion, and then it is possible to transmit from this computer to the vehicle the mapping information defining at least some of the mandatory passing zones, the traffic information defining the traffic in at least some of the mandatory passing zones, and the position information defining each determined relative position, and then it is possible to determine the path to follow in the vehicle, passing through one of the mandatory passing zones based on this mapping information, traffic information and position information;
in its step, it is possible to transmit from a computer, associated with the road portion, to the vehicle relative successive positions of the latter relative to a predefined location of at least one mandatory passing zone, until it comes out of the mandatory passing zone through which its path to follow passes, so that it determines its current absolute position from each relative position received and an absolute position of this predefined location, contained in the transmitted mapping information;
in its step, it is possible to determine in the vehicle successive absolute positions of the latter with respect to a predefined location of at least one mandatory passing zone based on distances deduced from data representative of the environment in front of the vehicle and determined by means of on-board analysis means in the latter, so that it has at every moment its absolute position relative to an absolute position of this predefined location, contained in the transmitted mapping information;
in its step, it is possible to transmit to the vehicle, from a computer associated with the road portion, a speed profile adapted to each mandatory passing zone, so that the driving of the vehicle is controlled on its path to follow respecting the speed profile adapted to the mandatory passing zone through which this path to follow passes;
in its step, it is possible to transmit to the vehicle status data indicating whether its automatic passage is authorized or not authorized, so that the speed of the vehicle, on its path to follow, is controlled according to this status data and a position of a virtual target located in the mandatory passing zone through which the path to follow passes, the vehicle remaining stationary just before this position of this virtual target as long as this transmitted status data does not represent an authorization;
in its step, the transmissions can be direct and at short range or carried out via a mobile communication network;
each mandatory passing zone may, for example, include a toll station.

A system for implementing the assistance method presented above is also disclosed and which comprises for this purpose at least one computer and a first communication module, installed in a portion of a road comprising at least two mandatory passing zones, and at least one vehicle present in this portion and having an assistance device cooperating with this computer to control the driving of the vehicle when passing through a mandatory passing zone.

### DESCRIPTION OF THE FIGURE

Other features and advantages of the method will become apparent from the following detailed description and the accompanying drawing, in which the single FIGURE schematically and functionally illustrates a road comprising a portion having mandatory passing zones, a vehicle authorized to drive in an automated zone and able to benefit from the disclosed assistance method, being about to enter in one of them.

### DETAILED DESCRIPTION

An assistance method is proposed which is intended to assist the driving of a vehicle V with autonomous driving when passing through a mandatory passing zone ZP1j or ZP2k of a portion PV of a road VC further comprising at least one other mandatory passing zone ZP1j or ZP2k, possibly automated.

In what follows, it is considered, by way of non-limiting example, that the vehicle V is of the automotive type. It is, for example, a car. But the invention is not limited to this type of vehicle. Indeed, it concerns any type of land vehicle that can perform movements and maneuvers on roads including mandatory passing zones. Thus, it also concerns motorcycles, coaches (or buses), trucks, commercial vehicles, and road vehicles.

Furthermore, it is considered in the following description, by way of non-limiting example, that the portion PV of road VC with mandatory passing zones ZP1j and ZP2k is a toll zone of an expressway. But the invention is not limited to this type of mandatory passing zone. It concerns any type of mandatory passing zone that is part of a portion of a road, whether or not it includes a toll barrier. Thus, it particularly concerns fast lanes, tunnels, bridges, car parks (exterior or interior), city entrances or sub-parts of cities (such as city centers), and airport areas. It should be noted that the method concerns not only the mandatory passing zones in which an over-the-air wave data exchange is carried out between a local control station and an electronic toll device (or badge) DT embedded in the vehicle V, but also the mandatory passing zones in which the registration of the vehicle V is recorded, for example by means of camera(s), without the need for the vehicle to comprise an electronic toll device (or badge) DT.

A portion PV of a road VC comprising five mandatory passing zones ZP1j and ZP2k able to be driven through by vehicles is diagrammatically represented in the single figure. Here, the portion PV includes three mandatory passing zones ZP11 to ZP13 (j=1 to 3) that do not allow a controlled automatic passage and are thus called non-automated, and two mandatory passing zones ZP21 and ZP22 (k=1 and 2) allowing a controlled automatic passage and thus called automated. It should be noted that for the method to be implemented, the portion PV of the road VC must comprise at least two mandatory passing zones, of which at least one is automated (ZP2k).

Each non-automated zone ZP1j includes a toll station SP located on one side of a lane in which vehicles can circulate and whose passage is possibly impeded by a rotationally mounted barrier BP.

Each automated zone ZP2k includes a toll station SP, equipped with a control device DC intended to control the passage of each vehicle, and located on one side of a lane in which vehicles can circulate, equipped (here) with an electronic toll device DT, and whose passage is possibly impeded by a rotationally mounted barrier BP.

Each control device DC is (here) designed to exchange data by over-the-air waves (short range) with an electronic toll device embedded DT embedded in a vehicle V.

As mentioned above, the invention relates more precisely to vehicles V equipped with a driver assistance device DA designed to control their positioning relative to transverse and longitudinal directions (and therefore with respect to the road VC) in order to allow their driving at least partially autonomously, that is to say without their drivers acting on their steering wheels or pedals. For example, this (driving) assistance device DA is of type ADAS (Advanced Driver Assistance System).

This assistance device DA controls the driving based, in particular, on the current position of its vehicle V and information provided by an analysis means MA embedded in the vehicle V and responsible for analyzing data representative of the environment in front of the vehicle V, acquired by acquisition means also embedded in the vehicle V. The acquisition means may, for example, comprise at least one camera and/or at least one scanning laser and/or at least one a radar or lidar and/or at least one ultrasound sensor.

Also, as mentioned above, the method proposes an assistance method intended to assist the driving of a vehicle V (with autonomous driving) when passing through a mandatory passing zone ZP1j or ZP2k of a portion PV of a road VC.

The implementation of this assistance method further requires that the portion PV be equipped with at least one computer CA and at least one first over-the-air wave communication module MC1, and that the vehicle V also includes a second over-the-air wave communication module MC2 (able to exchange messages with the first over-the-air wave communication module MC1) and a positioning device DP, for example by satellites, and capable, at least, to determine its current position. The transmissions between the first MC1 and the second MC2 over-the-air wave communication modules are preferably direct and at short range (possibly of “vehicle to infrastructure” type (Car2X or V2X, for example)). But these transmissions could be realized via a mobile communication network.

The assistance method comprises a step that is implemented each time a vehicle V (authorized and with autonomous driving) reaches the vicinity of the portion PV of the road VC. In this case, a relative position prV of this vehicle V with respect to a predefined location of at least one mandatory passing zone ZP1j or ZP2k is first determined. This determination may, for example, be carried out by the computer CA using data provided by detectors implanted in the ground and/or in security guardrails or walls of the portion PV and/or by cameras or lasers or radars or ultrasound detectors implanted on at least one side of the portion PV. For example, and without limitation, the computer CA can determine the relative position prV of the vehicle V relative to a predefined location of the first automated zone ZP21. Thus, even when the vehicle V is not detected by the detectors of the portion PV, it will still be able to use the measurement of its position performed by its positioning device DP (possibly of the differential type). Alternatively, it would be possible to transmit to the vehicle V its position in a local reference frame (for example, with respect to the computer CA) without using geographical coordinates (absolute), and when the vehicle V is not detected by the detectors of the portion PV, it will be able to estimate its position by odometry or SLAM (“Simultaneous Localization and Mapping”) by using the perception of its local environment provided by its analysis means MA. This predefined location may, for example and without limitation, be the location where the toll station SP of the first mandatory passing zone ZP21 is installed (here). But the computer CA could determine the relative position prV of the vehicle V with respect to a predefined location of each mandatory passing zone ZP1j or ZP2k or only of each automated zone ZP2k (when the vehicle V comprises an electronic toll device DT (or the like)). It will be understood that the computer CA has the geographic coordinates defining the absolute positions of the mandatory passing zones ZP1j and ZP2k, and therefore that it is able to deduce the current relative position prV of a vehicle V, detected in the portion PV, relative to at least one predefined location of this portion PV.

Then, for the vehicle V, a path TS is determined, which passes through a mandatory passing zone ZP1j or ZP2k as a function of mapping information defining at least some of the mandatory passing zones ZP1j and ZP2k, traffic information defining a traffic at least in some of the mandatory passing zones ZP1j and ZP2k, and to the/each relative position prV determined, is determined for the vehicle V. It will be seen later that this determination of the path to follow TS can be accomplished in different ways, in the computer CA or in the vehicle V.

It will be noted that when the vehicle V comprises an electronic toll device DT (or the like), it is possible to determine for the vehicle V a path to follow TS passing through an automated zone ZP2k based on mapping and traffic information relating only to the automated zones ZP2k.

Then, the driving of the vehicle V is controlled by means of its assistance device DA, so that it follows the determined path TS.

The path to follow TS being defined very precisely and the assistance device DA having very precise position information, as regards its vehicle V as well as the mandatory passing zone ZP1j or ZP2k that its vehicle V must traverse, this assistance device DA is therefore advantageously able to correctly and accurately manage the dynamics of its vehicle V during the entire traverse of this mandatory passing zone ZP1j or ZP2k, without its driver having to intervene (at least for driving). In addition, it is now certain that the path to follow TS will be determined only according to the mandatory passing zones ZP1j and ZP2k (possibly only those automated ZP2k) which are actually open and not faulty, which is known at every moment only by the computer CA.

The path to follow TS is, for example, the one that allows, a priori, to waste the least amount of time during the controlled automatic passage, given the traffic in each mandatory passing zone ZP1j or ZP2k (possibly only those automated ZP2k) and the relative position prV of vehicle V when detected for the first time in the portion PV. But it could also be the shortest or safest path or the most suitable for autonomous driving.

In the example illustrated in a non-limiting way in the single figure, considering zero traffic in each automated zone ZP2k and the fact that the vehicle V comprises an electronic toll device DT and has been detected in the rightmost part of the portion PV, located in the lane axis of the first automated zone ZP21 (k=1), the path to follow TS passes through this first automated zone ZP21.

At least three embodiments can be envisaged to determine the path to follow TS of the vehicle V to go through a mandatory passing zone ZP1j or ZP2k.

In a first embodiment, in the process step, it is possible to determine each relative position prV of the vehicle V and the path to follow TS in the computer CA which is associated with the portion PV. In this case, the definition of this path to follow TS is then transmitted from the computer CA to the vehicle V. It will be understood that the computer CA orders the first communication module MC1 (by over-the air waves) to transmit a message containing a definition of this path to follow TS to the second communication module MC2 (by over-the-air waves) of the vehicle V, and this second communication module MC2 transmits this definition to the assistance device DA of its vehicle V to control its driving in order to make it follow the defined path to follow TS.

The identification of the vehicle V and its communication identifier can be done in at least two ways.

A first way comprises determining the registration number of the vehicle V by means of images acquired by the cameras of the portion PV, then the computer CA searches for the communication identifier which is associated with this registration number in a subscriber file.

In a second way, the vehicle V can automatically connect to the first means of communication MC1 (here) of the toll zone by knowing its communication identifier (for example its IP address), then it can transmit its own geographical position (provided by its own positioning device DP). Thus, the first means of communication MC1 can identify it among all the vehicles approaching. It should be noted that this “unicast” type of communication solution is only necessary if one wants to send from the toll zone a path to follow TS and/or the position of the vehicle V.

In a second embodiment, in the process step, it is possible to start by determining each relative position prV of the vehicle V and paths respectively passing through at least some of the mandatory passing zones ZP1k and ZP2k (possibly only those automated ZP2k) in the computer CA that is associated with the portion PV. In this case, it is then possible to transmit from the computer CA to the vehicle V definitions of these determined paths, the mapping information defining at least some of the mandatory passing zones ZP1k and ZP2k (possibly only those automated ZP2k), the traffic information defining the traffic in at least some of the mandatory passing zones ZP1k and ZP2k (possibly only those automated ZP2k), and position information defining each relative position prV determined. It will be understood that the computer CA orders the first communication module MC1 to transmit a message containing the definitions of the paths and the aforementioned information to the second communication module MC2 of the vehicle V.

Then, it is possible to select, in the vehicle V, the path to follow TS among these determined (received) paths, based on this mapping information, traffic information and position information received. This selection can, for example, be carried out by the assistance device DA of the vehicle V, which will then control the driving of the latter (V) in order to make it take the path to follow TS that it just selected. But, in a variant, it could be envisaged that the vehicle V comprises a selection device, external to the assistance device DA while being coupled to the latter (DA), and responsible for selecting the path to follow TS among the determined paths received.

In this second embodiment, the identification of the vehicle V and its communication identifier is not mandatory. It can indeed be envisaged that the computer CA sends to all the vehicles (“broadcast” mode) a set of paths leading to each of the mandatory passing zones ZP1k and ZP2k (possibly only those automated ZP2k), as well as position corrections (for example, GPS) to improve the positioning of vehicles in the vicinity, and then the assistance device DA (or the aforementioned selection device) of each vehicle selects its own path to follow among this set.

In a third embodiment, in the process step, it is possible to start by determining each relative position prV of the vehicle V in the computer CA that is associated with the portion PV. In this case, it is then possible to transmit from the computer CA to the vehicle V the mapping information defining at least some of the mandatory passing zones ZP1k and ZP2k (possibly only those automated ZP2k), the traffic information defining the traffic in at least some of the mandatory passing zones ZP1k and ZP2k (possibly only those automated ZP2k), and position information defining each relative position prV determined. It will be understood that the computer CA orders the first communication module MC1 to transmit a message containing the aforementioned information to the second communication module MC2 of the vehicle V.

Then, it is possible to determine, in the vehicle V, the path to follow TS, which passes through one of the mandatory passing zones ZP1k and ZP2k (possibly only those automated ZP2k), according to this mapping information, traffic information and position information received. This determination may, for example, be carried out by the assistance device DA of the vehicle V, which will then control the driving of the latter (V) in order to make it take the path to follow TS that it just selected. But, in one variant, it could be envisaged that the vehicle V comprises a computing device, external to the assistance device DA while being coupled to the latter (DA), and responsible for determining the path to follow TS on the basis of the information received.

It should be noted that, in the process step, it is possible to transmit to the vehicle V from the computer CA, associated with the portion PV, successive relative positions prV of the vehicle V with respect to a predefined location of at least one mandatory passing zone ZP1j or ZP2k, until it comes out of the mandatory passing zone ZP1k or ZP2k through which the path to follow TS passes. It will be understood that the computer CA orders the first communication module MC1 to transmit successive messages respectively containing the successive relative positions prV of the vehicle V to the second communication module MC2 of the vehicle V.

Thus, it is possible to determine, in the vehicle V, its current absolute position from each relative position prV received and from an absolute position of the predefined location, contained in the mapping information. It should be noted that in the case of the first embodiment described above, this option requires that the computer CA instruct the first communication module MC1 to also transmit a message containing the aforementioned mapping information to the second communication module MC2 of the vehicle V. This message may also include the very first relative position prV of the vehicle V determined. Moreover, the determination of each absolute position may, for example, be carried out by the assistance device DA of the vehicle V, which will then control the driving of the vehicle V based on this determined absolute position, in order to make it take the path to follow TS. But, alternatively, it could be envisaged that the vehicle V comprises a computing device, external to the assistance device DA while being coupled to the assistance device DA, and responsible for determining each absolute position.

This last option makes it possible to avoid having to use current successive positions of the vehicle V supplied by its positioning device DP, which are a priori insufficiently precise and therefore unreliable.

It should also be noted that in the process step it is possible to determine in the vehicle V successive absolute positions of the vehicle V relative to a predefined location of at least one mandatory passing zone ZP1j or ZP2k based on distances deduced from data representative of the environment in front of the vehicle V and determined by the analysis means MA embedded in the vehicle V.

Thus, the vehicle V, and more precisely its assistance device DA, has at every moment its absolute position with respect to an absolute position of this predefined location, contained in the mapping information. It should be noted that in the case of the first embodiment described above, this option requires that the computer CA instructs the first communication module MC1 to transmit successive messages respectively containing the successive absolute positions of the vehicle V to the second communication module MC2 of the vehicle V.

This last option makes it possible to avoid having to use current successive positions of the vehicle V supplied by its positioning device DP, which are a priori insufficiently precise and therefore unreliable.

It should also be noted that, in the process step, it is possible to transmit to the vehicle V from the computer CA, associated with the portion PV, a speed profile adapted to each mandatory passing zone ZP1k or ZP2k (possibly only those automated ZP2k), so that the driving of the vehicle V is controlled on the path to follow TS while respecting the speed profile which is adapted to the mandatory passing zone ZP1k or ZP2k through which this path to follow TS passes. It will be understood that the computer CA orders the first communication module MC1 to transmit a message containing the/each speed profile adapted to the/each mandatory passing zone(s) ZP1k or ZP2k to the second communication module MC2 of the vehicle V, and this second communication module MC2 transmits the/each speed profile adapted to the/each mandatory passing zone(s) ZP1k or ZP2k to the assistance device DA of its vehicle V to control its driving in order to make it take the path to follow TS defined by respecting the speed profile concerned.

Each speed profile may, for example, be a decreasing speed law, possibly based on the traffic in the mandatory passing zone ZP1k or ZP2k, and/or the weather conditions/constraints, and/or local pollution, and/or the type or dynamics of the vehicle (for safety and/or comfort reasons).

It should also be noted that, in the process step, it is possible to transmit to the vehicle V status data indicating whether the automatic passage is authorized or not authorized (here, by the control device DC of the toll station SP concerned). For example, the computer CA may be informed by this control device DC of the authorized or unauthorized status, and may instruct the first communication module MC1 to transmit successive messages containing the status data defining the current status to the second communication module MC2 of the vehicle V, and this second communication module MC2 transmits the status data to the assistance device DA of its vehicle V. Alternatively, the control device DC concerned may address to the electronic toll device DT of the vehicle V the successive status data, and this electronic toll device DT may transmit the status data to the assistance device DA of its vehicle V.

Thus, one (the assistance device DA) can control the speed of the vehicle V on the path to follow TS based on the status data and on a position of a virtual target located in the mandatory passing zone ZP1k or ZP2k through which the path to follow TS passes. The vehicle V remains stationary just before this position of the virtual target as long as the status data is not representative of a passage authorization generated by the control device DC concerned. The virtual target may, for example, be (here) the barrier BP of the mandatory passing zone ZP1k or ZP2k. But when another vehicle precedes the vehicle V in the mandatory passing zone ZP1k or ZP2k, this virtual target may be the rear part of this other vehicle. It will be noted that the position of the virtual target of the mandatory passing zone ZP1k or ZP2k (for example the barrier BP) can be transmitted from the computer CA, associated with the portion PV, to the vehicle V, by means of a dedicated message or of a message containing at least one position (relative or absolute) and/or information among those mentioned above. In the case of a transmission in broadcast mode, it is possible, for example, to send to all vehicles a set of paths and information on at least some of the mandatory passing zones ZP1k and ZP2k (possibly only those automated ZP2k) open and closed, and therefore each vehicle V is able to understand if the passage authorization concerns it or if it concerns another vehicle in front of it in the same mandatory passing zone ZP1k or ZP2k thanks to the analysis carried out by its analysis means MA.

This last option makes it possible to avoid having to wait for the analysis means MA to generate information indicating the detection of the passage authorization following the detection of the lifting of the barrier BP of the mandatory passing zone ZP1k or ZP2k concerned and/or the change to the color green of the traffic light of this mandatory passing zone ZP1k or ZP2k, which proves quite often difficult to detect given, in particular, their close proximity to the means of acquisition of the vehicle V or the fact that these are objects that are not recognizable in the database of the objects learned by the vehicle V (for example because of a shape and/or specific colors (here) at the toll zone).

It should also be noted that the passage via an automated zone ZP2k takes place, a priori, without any intervention from the driver of the vehicle V since the electronic toll device DT cooperates with the control device DC (here) of the toll station SP. But when the passage takes place via a non-automated zone ZP1j, the driver of the autonomous vehicle must pay or present a pass card once his vehicle stops at the station SP, and once he has done the latter operation, the computer CA transmits to his vehicle V status data signaling the authorization so that the assistance device DA restarts the vehicle.

The assistance device DA may be advantageously modified, with respect to a prior art assistance device, in order to take into account the abovementioned positions (relative or absolute) and/or the aforementioned information and/or the definitions of aforementioned paths and/or the aforementioned speed profiles and/or any eventual aforementioned status data. This modification can be done by modifying and/or adding software module(s) and/or by modifying and/or adding electronic circuits (or “hardware”).

It will also be noted that the invention also proposes a system intended to implement the assistance method described above, and comprising:
at least one computer CA and a first communication module MC1, installed in a portion PV of a road VC comprising at least two mandatory passing zones ZP1j and ZP2k, and
at least one vehicle V present in this portion PV and comprising an assistance device DA cooperating with this computer CA to control the driving of its vehicle V when it passes through a mandatory passing zone ZP1j or ZP2k.

1. A method for assisting the driving of an autonomous vehicle on a road having a portion provided with at least two mandatory passing zones, said vehicle comprising a driving assistance system and being adapted to communicate by over-the-air waves, said vehicle being autonomously controlled by said driving assistance system as a function of a position of said vehicle, the method comprising:
determining a relative position of said vehicle is determined with respect to a predefined location of at least one of said mandatory passing zones when said vehicle reaches the vicinity of said portion of said road, a step in which; then
determining a path to follow for said vehicle which passes through one of said at least one mandatory passing zones, said path to follow being determined as a function of mapping information defining at least some of the mandatory passing zones, traffic information defining traffic in at least some of the mandatory passing zones, and said determined relative position; and
then, the said driving assistance system autonomously driving said vehicle so that said vehicle takes the path to follow.

2. The method according to claim 1, wherein each relative position of said vehicle and said path to follow are determined in a computer associated with said portion of said road, and wherein said definition of the path to follow is transmitted from said computer to said vehicle.

3. The method according to claim 1, wherein, each relative position of said vehicle and paths passing respectively through at least some of the mandatory passing zones are determined in a computer associated with said portion of said road; and then said computer transmitting to said vehicle the definitions of these determined paths; said mapping information defining at least some of the mandatory passing zones, said traffic information defining the traffic in at least some of the mandatory passing zones, and said position information defining each determined relative position, then said vehicle selecting the path to follow from among said determined paths, according to said mapping information, said traffic information and said position information.

4. The method according to claim 1, wherein, each relative position of said vehicle is determined in a computer associated with said portion of said road; then said mapping information defining at least some of the mandatory passing zones, said traffic information defining the traffic in at least some of the mandatory passing zones, and said position information defining each determined relative position are transmitted by said computer to said vehicle; then said path to follow passing through one of said mandatory passing zones is determined in said vehicle, based on said mapping information, said traffic information and said position information.

5. The method according to claim 1, wherein, successive relative positions of the vehicle with respect to a predefined location of at least one mandatory passing zone are transmitted from a computer associated with said portion of said road to said vehicle until the vehicle leaves the mandatory passing zone through which said path to follow passes, in order to determine the vehicle's current absolute position from each relative position received and an absolute position of said predefined location contained in said mapping information.

6. The method according to claim 1, wherein said vehicle includes analysis means for determining a distance in front of said vehicle, wherein successive absolute positions of the vehicle relative to a predefined location of at least one mandatory passing zone according to distances deduced from data representative of the environment in front of said vehicle and determined by said analysis means are determined in said vehicle, so that at all times the absolute position of said vehicle relative to an absolute position of said predefined location is contained in said mapping information.

7. The method according to claim 1, wherein, a speed profile associated with each mandatory passing zone is transmitted from a computer associated with said portion of said road to said vehicle, so that the driving of said vehicle is controlled on said path to follow while respecting the speed profile of the mandatory passing zone (ZP1j, ZP2k) through which this path to follow passes.

8. The method according to claim 1, wherein status data indicating whether automatic passage of said vehicle is authorized or not authorized is transmitted to said vehicle so that the speed of said vehicle is controlled on said path to follow based on the status data and a position of a virtual target located in the mandatory passing zone through which said path to follow passes, said vehicle remaining stationary just before the position of said virtual target as long as said status data is not representative of an authorization.

9. The method according to claim 1, wherein each mandatory passing zone comprises a toll station.

10. A system to implement the assistance method according to claim 1, wherein the system comprises at least one computer and a first communication module installed in a portion of a road comprising at least two mandatory passing zones, and at least one vehicle present in said portion of said road and said vehicle having an assistance device cooperating with said computer to control the driving of said vehicle during passage of the vehicle through a mandatory passing zone.
